(19) United States
(12) Patent Application Publication
(10) Pub. No.: US 2021/0080718 A1
(43) Pub. Date: Mar. 18, 2021

(54) HEAD-UP DISPLAY DEVICE

(71) Applicant: NIPPON SEIKI CO., LTD., Niigata (JP)

(72) Inventors: Genichiro SATO, Niigata (JP); Shuichi YAMAYA, Niigata (JP)

(21) Appl. No.: 16/772,979

(22) PCT Filed: Dec. 18, 2018
(86) PCT No.: PCT/JP2018/046438

§ 371 Date: Jun. 15, 2020

(30) Foreign Application Priority Data
Dec. 21, 2017 (JP) 2017-245505

(51) Int. Cl. G02B 27/01; G02B 7/182

(52) U.S. Cl. CPC G02B 27/0149; G02B 2027/0154; G02B 27/0101; G02B 7/182

(57) ABSTRACT

A head-up display device is provided with which it is possible to suppress distortion of a mirror surface. The head-up display device comprises a mirror unit that reflects display light from a display unit onto a front glass, which is one example of a projection mirror. The mirror unit comprises a concave mirror, a concave mirror holder, a mirror drive unit, a torsion spring, and positioning recessed sections, and the adhesive surface sections that are one example of a contact section that contacts the recessed mirror provided in the recessed mirror holder. The positioning recessed sections and the adhesive surface sections are provided in regions excepting a displacement occurrence region in which there is a possibility of displacement of the recessed mirror holder due to a biasing part of the torsion spring biasing the recessed mirror holder.

### TECHNICAL FIELD

The present invention relates to a head-up display device.

### BACKGROUND ART

Conventionally, a head-up display device that includes a display unit that emits display light representing an image, and a concave mirror that reflects the display light from this display unit onto a projection member has been known. For example, as disclosed in PTL 1, the concave mirror includes a concave mirror body and a holding plate that supports this concave mirror body. One end of a first spring is locked to the holding plate, and the other end of the first spring is locked to a case.

### PRIOR ART DOCUMENT

### Patent Document

PTL 1: Japanese Unexamined Patent Application Publication No. 2011-131651

### SUMMARY OF THE INVENTION

### Problems to be Solved by the Invention

In the configuration described in above PTL 1, a mirror surface of the concave mirror is possibly distorted due to an external force applied to the holding plate from the first spring. In particular, because the display light is augmented in the concave mirror, an impact of the slight distortion of the mirror surface on a virtual image that is displayed by the head-up display device is not insignificant. Thus, it is desired to particularly suppress the distortion of the mirror surface.

The present invention has been made in view of the above circumstance and therefore has a purpose of providing a head-up display device capable of suppressing distortion of a mirror surface.

### Solution to Problem

In order to achieve the above purpose, a head-up display device according to an aspect of the present invention is a head-up display device including a display unit that emits display light, and a mirror unit that reflects the display light from the display unit onto a projection member, in which the mirror unit includes a concave mirror including a mirror surface that reflects the display light, a concave mirror holder including a main body that holds the concave mirror, a pair of rotational shafts that extends along a rotational axis from both sides of the main body, and a held section that extends from the main body in a direction crossing the rotational axis, a mirror drive unit that includes a holding concave section sandwiching the held section from a direction orthogonal to the rotation axis and causes the concave mirror holder to rotate with the concave mirror about the rotation axis by moving the holding concave section along the direction orthogonal to the rotation axis, a torsion spring including a coil that is inserted through any one of the pair of rotational shafts and a biasing part that extends from the coil and biases the concave mirror holder so as to bring the held section into contact with the holding concave section, and a contact section that contacts the concave mirror provided in the concave mirror holder, and the contact section is provided in a region of the concave mirror holder excluding a displacement occurrence region where displacement possibly occurs when the biasing part biases the concave mirror holder.

### Effect of the Invention

According to the present invention, in the head-up display device, it is possible to suppress distortion of the mirror surface.

### BRIEF DESCRIPTION OF THE DRAWINGS

FIG. 1 is a schematic view of a vehicle on which a head-up display device according to an embodiment of the present invention is mounted.

FIG. 2 is a schematic view illustrating a configuration of the head-up display device according to the embodiment of the present invention.

FIG. 3 is a perspective view of a mirror unit according to the embodiment of the present invention.

FIG. 4 is a left side view of the mirror unit according to the embodiment of the present invention.

FIG. 5 is an enlarged view of a portion corresponding to a mirror drive unit in

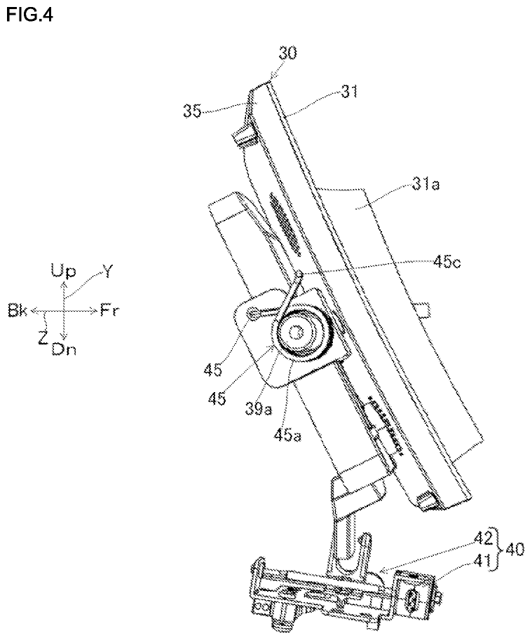

FIG. 4.

FIG. 6 is a perspective view of a back surface side of a concave mirror according to the embodiment of the present invention.

FIG. 7 is a perspective view of a front surface side of a concave mirror holder according to the embodiment of the present invention.

FIG. 8 is a left side view of the mirror unit according to the embodiment of the present invention.

### MODE FOR CARRYING OUT THE INVENTION

A description will be made on an embodiment of a head-up display device according to the present invention with reference to the drawings.

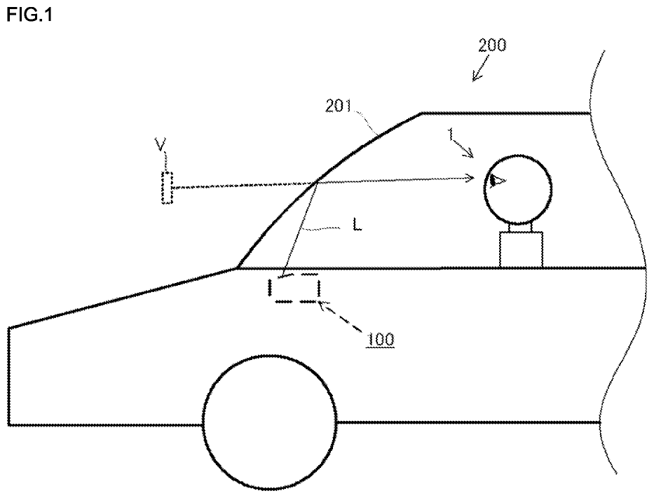

As illustrated in FIG. 1, a head-up display device 100 is installed in a dashboard of a vehicle 200. The head-up display device 100 emits display light L representing an image toward a front glass 201 that is an example of a projection member of the vehicle 200. The display light L is reflected by the front glass 201 and reaches a viewer 1 (mainly a driver of the vehicle 200). As a result, a virtual image V is displayed in a manner to be visually recognizable by the viewer 1.

(Configuration of Head-up Display Device)

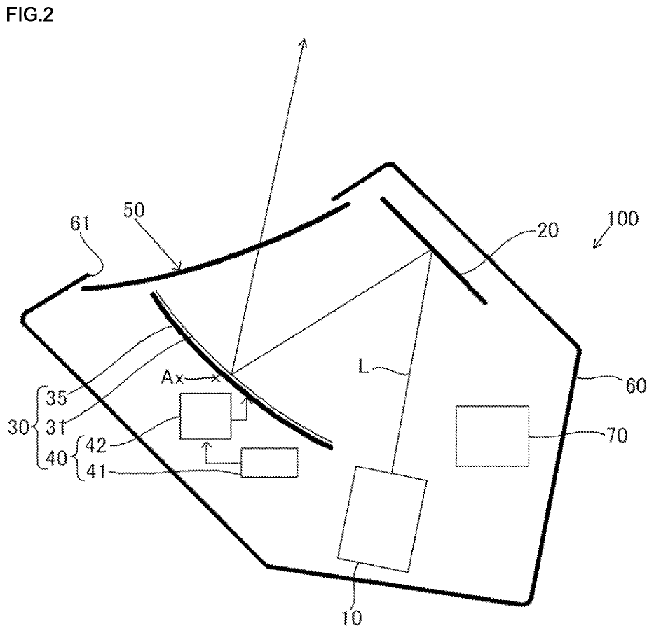

As illustrated in FIG. 2, the head-up display device 100 includes a display unit 10, a reflective mirror member 20, a mirror unit 30, a casing 60, and a control unit 70.

The casing 60 is made of a non-translucent resin material or a metal material and has a hollow rectangular parallelepiped shape. The casing 60 has an opening 61 formed at a position opposing the front glass 201. The casing 60 includes a window 50 in a curved plate shape that closes the opening 61. This window 50 is made of a translucent resin material such as acrylic through which the display light L passes. All components of the head-up display device 100 are stored in the casing 60.

The display unit 10 emits the display light L representing the image under control of the control unit 70. The display unit 10 includes a light source and a liquid crystal display panel, which are not illustrated.

The reflective mirror member 20 reflects the display light L emitted by the display unit 10 toward the mirror unit 30. The reflective mirror member 20 is formed by laminating aluminum on a base material made of resin such as polycarbonate, for example.

The mirror unit 30 augments and reflects the display light L, which is emitted from the display unit 10 and reflected by the reflective mirror member 20, toward the front glass 201. The mirror unit 30 is configured to be rotatable about a rotation axis Ax that extends in a direction perpendicular to the sheet of FIG. 2.

(Configuration of Mirror Unit)

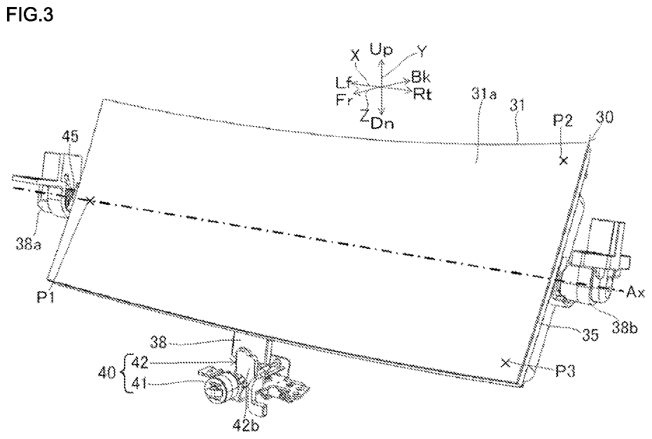

As illustrated in FIG. 3 and FIG. 4, the mirror unit 30 includes a concave mirror 31 that reflects the display light L, a concave mirror holder 35 that holds the concave mirror 31, a mirror drive unit 40 that rotates the concave mirror holder 35 together with the concave mirror 31, a torsion spring 45 that biases the concave mirror holder 35, and shaft holders 38a, 38b that rotatably support the concave mirror holder 35. In the following description, left, right, up, down, front, and back are defined on the basis of a direction in which the mirror unit 30 is seen from the front. In FIG. 3 to FIG. 8, the left is abbreviated as Lf, the right is abbreviated as Rt, the up is abbreviated as Up, and the down is abbreviated as Dn, the front is abbreviated as Fr, and the back is abbreviated as Bk. Also, a right-left direction matches an X-direction, an up-down direction matches a Y-direction, and a front-back direction matches a Z-direction.

The concave mirror 31 is formed in a substantially rectangular plate shape that is long in the X-direction, and is curved along the X-direction. More specifically, the concave mirror 31 includes a base material that is made of a synthetic resin and includes a concave curved surface having a specified curvature, and a mirror surface 31a that is made of metal such as aluminum and is deposited on the curved surface of the base material. The base material of the concave mirror 31 is, for example, made of the synthetic resin such as cycloolefin polymer (COP) resin or glass.

As illustrated in FIG. 6, the concave mirror 31 includes a back surface 31b that opposes the concave mirror holder 35, and first to third positioning projected sections 32a to 32c, each of which is formed in a convex shape on the back surface 31b. Each of the positioning projected sections 32a to 32c is formed in a columnar shape that has a spherical tip projected to the back side.

The first positioning projected section 32a is located at a left edge and a center in the Y-direction of the back surface 31b of the concave mirror 31. The second positioning projected section 32b is located at an upper right corner of the back surface 31b of the concave mirror 31. The third positioning projected section 32c is located at a lower right corner of the back surface 31b of the concave mirror 31.

The back surface 31b of the concave mirror 31 is formed with a plurality of adhesive projected sections 31c that oppose adhesive surface sections 37a to 37h of the concave mirror holder 35, which will be described later with reference to FIG. 7. In a circular area, each of the adhesive projected sections 31c includes a plurality of projections that extend in parallel along the X-direction. As a result, as illustrated in FIG. 8, it is possible to increase an area where each of the adhesive projected sections 31c contacts an adhesive 46 and thus to make the concave mirror 31 further reliably adhere to the concave mirror holder 35.

As illustrated in FIG. 7, the concave mirror holder 35 is made of a synthetic resin and is rotatably supported along the rotation axis Ax that extends in the X-direction while holding the concave mirror 31 from the back surface 31b. In detail, the concave mirror holder 35 includes a main body 34, a pair of rotational shafts 39a and 39b, and a held section 38.

The main body 34 has a rectangular plate shape along the back surface 31b of the concave mirror 31. The main body 34 includes first to third positioning recessed sections 36a to 36c, to which the first to third positioning projected sections 32a to 32c of the concave mirror 31 described above with reference to FIG. 6 are respectively fitted, the adhesive surface sections 37a to 37h that the back surface 31b of the concave mirror 31 contact via adhesives, a plurality of ribs 34a to 34i that improve strength of the main body 34, and a biased section 33 that is biased by the torsion spring 45.

Each of the first to third positioning recessed sections 36a to 36c is formed in a concave shape on a front surface 35f of the concave mirror holder 35. In the concave mirror holder 35, the front surface 35f is a surface that opposes the back surface 31b of the concave mirror 31. The first to third positioning recessed sections 36a to 36c each are arranged to be positioned at three vertices of an imaginary triangle Tr that has a short side extending in the Y-direction of the main body 34 in the concave mirror holder 35 as a base and a long side thereof extending in the X-direction as a height. In this example, the triangle Tr is an isosceles triangle, two base angles of this isosceles triangle are located at two right corners of the main body 34, and a vertex angle is located at the center in the Y-direction of a left edge of the main body 34. In this example, the first positioning recessed section 36a is located at the vertex that corresponds to the vertex angle, the second positioning recessed section 36b is located at the vertex that corresponds to the upper corner of the above two corners, and the third positioning recessed section 36c is located at the vertex that corresponds to the lower corner of the above two corners.

The first positioning recessed section 36a corresponds to the first positioning projected section 32a of the concave mirror 31, which has been described above with reference to FIG. 6, and is located at a left edge and a center in the Y-direction of the front surface 35f. The first positioning recessed section 36a is formed by a conical hole. A tip of the first positioning projected section 32a fits into the first positioning recessed section 36a. As a result, at a first abutment position P1 (see FIG. 3) at which the first positioning projected section 32a abuts the first positioning recessed section 36a, the concave mirror 31 is fixed to the concave mirror holder 35 in the X-direction, the Y-direction, and the Z-direction.

The second positioning recessed section 36b corresponds to the second positioning projected section 32b of the concave mirror 31 and is located at an upper right corner of the front surface 35f. The second positioning recessed section 36b formed by a V-shaped hole that extends along an imaginary connection line A connecting the first positioning recessed section 36a and the second positioning recessed section 36b. A tip of the second positioning projected section 32b fits into the second positioning recessed section 36b. As a result, at a second abutment position P2 (see FIG. 3) at which the second positioning projected section 32b abuts the second positioning recessed section 36b, the concave mirror 31 is fixed to the concave mirror holder 35 in the Y-direction and the Z-direction. Since the second positioning recessed section 36b extends along the connection line A, the second positioning projected section 32b is located within the second positioning recessed section 36b regardless of a shape error of the concave mirror holder 35 (particularly, the shape error thereof in the X-direction).

The third positioning recessed section 36c corresponds to the third positioning projected section 32c of the concave mirror 31 and is located at a lower right corner of the front surface 35f. The third positioning recessed section 36c includes a bottom surface 36c1 that is a plane extending along an X-Y plane. An area of the bottom surface 36c1 is set such that the third positioning projected section 32c is located on the bottom surface 36c1 regardless of the shape error of the concave mirror holder 35 in the X-direction and the Y-direction. A tip of the third positioning projected section 32c abuts the bottom surface 36c1 of the third positioning recessed section 36c. As a result, at a third abutment position P3 (see FIG. 3) at which the third positioning projected section 32c abuts the bottom surface 36c1 of the third positioning recessed section 36c, the concave mirror 31 is fixed to the concave mirror holder 35 in the Z-direction. With positioning at the first to third abutment positions P1, P2, and P3, the concave mirror 31 is fixed to the concave mirror holder 35 in the X-direction, the Y-direction, and the Z-direction.

As illustrated in FIG. 7, each of the adhesive surface sections 37a to 37h is formed in a disc shape and arranged in a region of the front surface 35f of the concave mirror holder 35 excluding a displacement occurrence region 35a. The displacement occurrence region 35a defines a rectangle that is long in the X-direction at a position above the first positioning recessed section 36a in the front surface 35f of the concave mirror holder 35, in other words, in an upper left portion of the front surface 35f. The displacement occurrence region 35a is a region where displacement possibly occurs when a biasing part 45b of the torsion spring 45, which will be described later, biases the concave mirror holder 35, and is set by an experiment or a simulation. As illustrated in FIG. 8, due to the displacement of the concave mirror holder 35, the displacement occurrence region 35a of the main body 34 is separated from the back surface 31b of the concave mirror 31 so as not to contact the concave mirror 31. On the front surface 35f of the main body 34, the displacement occurrence region 35a is formed with an inclined surface 35g that is inclined upward in a manner to be separated from the back surface 31b of the concave mirror 31. The inclined surface 35g prevents the front surface 35f of the main body 34 from contacting the back surface 31b of the concave mirror 31.

As illustrated in FIG. 7, the adhesive surface sections 37a, 37c, and 37f are aligned along an upper edge of the main body 34 of the concave mirror holder 35 excluding the displacement occurrence region 35a. The adhesive surface sections 37b, 37d, 37g, and 37h are aligned along a lower edge of the main body 34 of the concave mirror holder 35. The adhesive surface section 37e is located substantially at a center of the front surface 35f of the main body 34.

Concave-convex grooves 37j are formed in a surface of each of the adhesive surface sections 37a to 37h. The adhesive before curing is accumulated in the concave-convex grooves 37j of each of the adhesive surface sections 37a to 37h. In this state, each of the adhesive surface sections 37a to 37h is brought into contact with the adhesive projected section 31c of the concave mirror 31, which has been described above with reference to FIG. 6. As a result, as illustrated in FIG. 8, the concave mirror holder 35 adheres to the back surface 31b of the concave mirror 31 via the cured adhesives 46. For example, the adhesive 46 is an adhesive containing a heat-reversible resin component.

As illustrated in FIG. 7, the plurality of the ribs 34a to 34i is provided in the region of the front surface 35f of the concave mirror holder 35 excluding the displacement occurrence region 35a. The rib 34a extends in a direction along the rotation axis Ax in a manner to connect the adhesive surface sections 37a, 37c, and 37f. The rib 34b extend in the direction along the rotation axis Ax in a manner to connect the adhesive surface sections 37b, 37d, 37g, and 37h. The plurality of ribs 34c are parallel to each other and extend upward in a manner to be inclined to the left. The plurality of ribs 34d are parallel to each other and extend upward in a manner to be inclined to the right. A pair of the ribs 34e extends in parallel in a manner to connect the pair of rotational shafts 39a and 39b.

A back surface of the concave mirror holder 35 is formed with unillustrated ribs that are similar to those on the front surface 35f. The ribs on the back surface of the concave mirror holder 35 are also formed in the displacement occurrence region 35a.

The adhesive surface sections 37a to 37h and the first to third positioning recessed sections 36a to 36c are examples of the contact sections.

As illustrated in FIG. 7, the biased section 33 has a rectangular plate shape extending in a direction orthogonal to the rotation axis Ax, and is located at a position on a left surface of the main body 34 and at the center in the Y-direction. As illustrated in FIG. 8, the biased section 33 is formed with a locking hole 33a that is located above the rotational shaft 39a, which will be described later, and penetrates the biased section 33 in a thickness direction (the X-direction).

As illustrated in FIG. 7, a pair of the rotational shafts 39a and 39b has a columnar shape that extends along the rotation axis Ax from both sides of the main body 34. The rotational shaft 39a is provided on a left side surface of the main body 34, precisely, a left surface of the biased section 33. The rotational shaft 39b is provided on a right side surface of the main body 34.

The held section 38 has a rectangular plate shape that extends in the direction orthogonal to the rotation axis Ax from the main body 34. The held section 38 has a thickness direction that matches the Z-direction, and is located at a position on a lower side surface of the main body 34 and at a center in the X-direction.

The torsion spring 45 is formed by winding a metal wire. The torsion spring 45 includes a coil 45a, the biasing part 45b that extends from one end of the coil 45a, and a locking section 45c that extends from the other end of the coil 45a.

The rotational shaft 39a is inserted through the coil 45a. The coil 45a is elastically deformed in a linear direction along the rotation axis Ax and in a rotational direction about the rotation axis Ax. When being elastically deformed in this linear direction, the coil 45a elastically presses the concave mirror holder 35 toward a shaft holder 38b, which will be described later. In this way, a position of the concave mirror holder 35 in the linear direction along the rotation axis Ax is determined.

The locking section 45c of the torsion spring 45 is locked to a shaft holder 38a, which will be described later, and thereby elastically deforms the coil 45a in a manner to be twisted around the rotation axis Ax.

The biasing part 45b extends linearly from the coil 45a in the direction orthogonal to the rotation axis Ax. A tip of the biasing part 45b is bent at right angles to the direction along the rotation axis Ax, and is inserted in the locking hole 33a of the biased section 33. The torsion spring 45 biases the concave mirror holder 35 in a biasing rotational direction R, which is indicated by an arrow in FIG. 7, via the biasing part 45b.

As illustrated in FIG. 3 and FIG. 7, the shaft holder 38a accommodates the rotational shaft 39a and the torsion spring 45 while supporting the rotational shaft 39a in a manner to allow rotation thereof. The shaft holder 38b accommodates the rotational shaft 39b while supporting the rotational shaft 39b in a manner to allow rotation thereof. The shaft holders 38a and 38b are fixed to the casing 60.

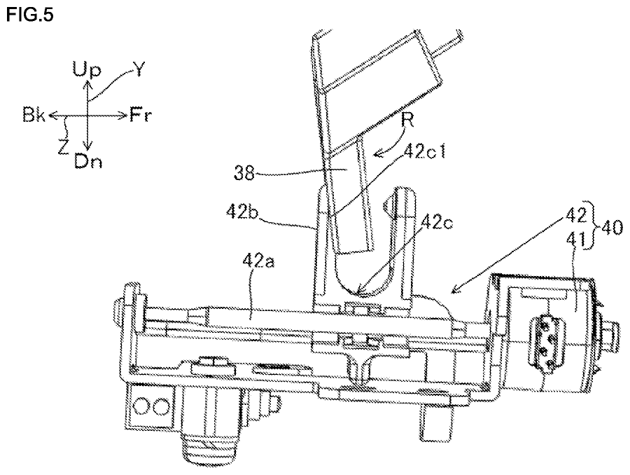

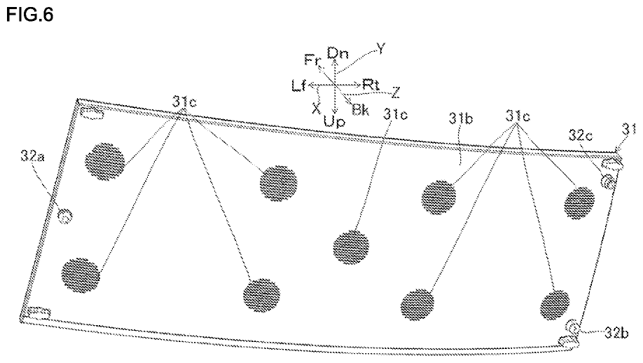

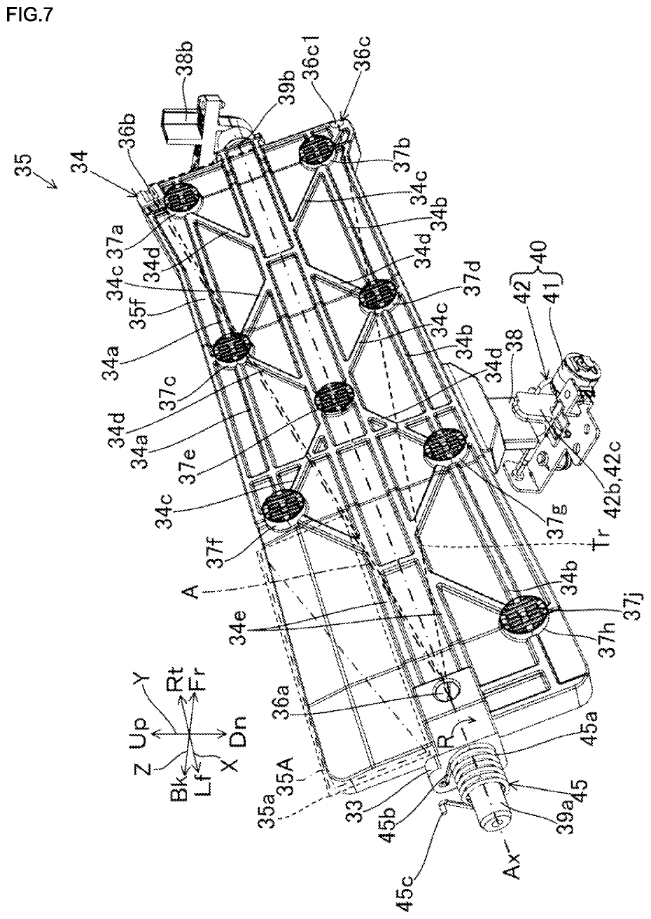

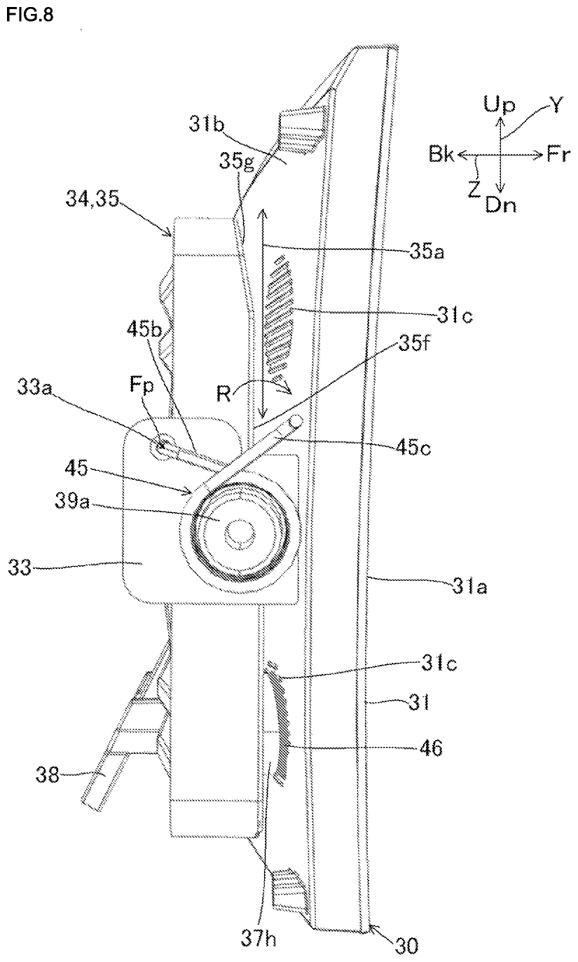

As illustrated in FIG. 5, the mirror drive unit 40 includes a motor 41 and a conversion mechanism 42.

The motor 41 is fixed inside the casing 60 and is driven under the control of the control unit 70. The conversion mechanism 42 is a mechanism that converts rotary motion of the motor 41 to linear motion. In detail, the conversion mechanism 42 includes a screw shaft 42a whose outer periphery is threaded, and a movable section 42b that is partially screwed to the outer periphery of the screw shaft 42a. When the screw shaft 42a rotates in conjunction with driving of the motor 41, the movable section 42b moves along the screw shaft 42a. The movable section 42b includes a holding concave section 42c that holds the held section 38 of the mirror unit 30 from a thickness direction thereof. On an inner side of the holding concave section 42c, a contact surface 42c1 is provided at the back. When the concave mirror holder 35 is biased in the biasing rotational direction R by the torsion spring 45, the held section 38 comes into contact with the contact surface 42c1 of the holding concave section 42c.

(Displacement of Mirror Unit)

As illustrated in FIG. 8, the torsion spring 45 applies a force in the biasing rotational direction R to the locking position Fp where the biasing part 45b is locked in the locking hole 33a via the biasing part 45b. As a result, the concave mirror holder 35, in the displacement occurrence region 35a which is provided above the locking position Fp, is deformed. A displacement amount of the concave mirror holder 35 is increased as the concave mirror holder 35 is separated upward from the locking position Fp. The displacement occurrence region 35a of the concave mirror holder 35 does not contact the concave mirror 31. Therefore, the concave mirror 31 is prevented from being distorted due to the displacement of the concave mirror holder 35.

### Effects

The embodiment that has been described so far exerts the following effects.

(1) The head-up display device 100 includes the display unit 10 that emits the display light L, and the mirror unit 30 that reflects the display light L from the display unit 10 onto the front glass 201 as the example of the projection member. The mirror unit 30 includes the concave mirror 31 including the mirror surface 31a that reflects the display light L, the concave mirror holder 35 including the main body 34 that holds the concave mirror 31, the pair of the rotational shafts 39a and 39b that extends from both of the sides of the main body 34 along the rotation axis Ax, and the held section 38 that extends from the main body 34 in the direction crossing the rotation axis Ax, the mirror drive unit 40 that includes the holding concave section 42c sandwiching the held section 38 from the direction orthogonal to the rotation axis Ax and causes the mirror unit 30 to rotate about the rotation axis Ax by moving the holding concave section 42c along the direction orthogonal to the rotation axis Ax, the torsion spring 45 including the coil 45a that is inserted through the rotational shaft 39a and the biasing part 45b that extends from the coil 45a and biases the concave mirror holder 35 so as to bring the held section 38 into contact with the holding concave section 42c, and positioning recessed sections 36a to 36c and the adhesive surface sections 37a to 37h as the examples of the contact sections that contact the concave mirror 31 provided in the concave mirror holder 35. The positioning recessed sections 36a to 36c and the adhesive surface sections 37a to 37h are provided in the region of the concave mirror holder 35 excluding the displacement occurrence region 35a where the displacement possibly occurs when the biasing part 45b biases the concave mirror holder 35.

According to this configuration, the displacement of the concave mirror holder 35 is suppressed from being transmitted to the concave mirror 31 via the positioning recessed sections 36a to 36c and the adhesive surface sections 37a to 37h. Thus, it is possible to suppress the distortion of the mirror surface 31a of the concave mirror 31. As a result, it is possible to improve display quality of the virtual image V that is displayed on the head-up display device 100.

(2) The biasing part 45b is locked to the side surface of the concave mirror holder 35. The displacement occurrence region 35a is provided in the region of the front surface 35f of the concave mirror holder 35, the region being farther from the rotational shaft 39a than the locking position Fp at which the biasing part 45b is locked.

According to this configuration, it is possible to suppress the distortion of the mirror surface 31a of the concave mirror 31.

(3) The main body 34 includes the inclined surface 35g that is formed at an end of the displacement occurrence region 35a far from the locking position Fp and is inclined in the manner to be separated from the back surface 31b of the concave mirror 31 as being separated from the rotational shaft 39a.

According to this configuration, as described above, with a biasing force from the biasing part 45b, the displacement amount of the main body 34 is increased toward a top of the main body 34. Therefore, when the main body 34 is formed with the inclined surface 35g in a manner to be separated further from the back surface 31b of the concave mirror 31 toward the top, it is possible to further reliably suppress the front surface 35f of the main body 34 from contacting the back surface 31b of the concave mirror 31.

(4) The concave mirror holder 35 includes, as the contact sections the adhesive surface sections 37a to 37h, each of which adheres to the concave mirror 31, and the positioning recessed sections 36a to 36c as the examples of holder positioning sections that respectively contact the positioning projected sections 32a to 32c as examples of concave mirror positioning sections formed in the concave mirror 31 so as to determine the position of the concave mirror 31 with respect to the concave mirror holder 35.

According to this configuration, the adhesive surface sections 37a to 37h and the positioning recessed sections 36a to 36c are provided in the region other than the displacement occurrence region 35a. Therefore, it is possible to suppress the distortion of the mirror surface 31a of the concave mirror 31 while fixing the concave mirror 31 to the concave mirror holder 35 with high positional accuracy.

(5) The main body 34 has the rectangular plate shape that is long along the rotation axis Ax. The first to third positioning recessed sections 36a to 36c are arranged to be positioned at the three vertices of the triangle Tr that has the short side extending in the Y-direction of the main body 34 orthogonal the rotation axis Ax as the base and a long side thereof extending in the X-direction along the rotation axis Ax as the height.

According to this configuration, the concave mirror holder 35 can stably hold the concave mirror 31 at three positions, that is, the first abutment position P1, the second abutment position P2, and the third abutment position P3 illustrated in FIG. 3. Therefore, it is possible to further reliably secure a clearance between the displacement occurrence region 35a of the main body 34 and the back surface 31b of the concave mirror 31.

(6) The first positioning recessed section 36a has the conical hole to which the first positioning projected section 32a in the convex shape fits, the second positioning recessed section 36b has the V-shaped hole to which the second positioning projected section 32b in the convex shape is fitted and which extends along the imaginary connection line A that connects the first positioning recessed section 36a and the second positioning recessed section 36b, and the third positioning recessed section 36c has the bottom surface 36c1 as the plane that the third positioning projected section 32c in the convex shape abuts.

According to this configuration, the third positioning recessed section 36c positions the third positioning projected section 32c not in the X-Y-direction but only in the Z-direction. Meanwhile, the second positioning recessed section 36b positions the second positioning projected section 32b not in a direction along the connection line A, that is, in the substantially Y-direction but in a direction orthogonal to the connection line A, that is, in the substantially X-direction and the Z-direction. Just as described, a non-positioning direction, that is, a non-restricting direction is set for each of the second positioning recessed section 36b and the third positioning recessed section 36c. As a result, the concave mirror holder 35 can stably hold the concave mirror 31 while restricting the concave mirror 31 at the minimum. Therefore, it is possible to suppress the mirror surface 31a of the concave mirror 31 from being distorted.

### Modified Embodiments

The above embodiment can be implemented in the following embodiments in which the above embodiment is appropriately changed.

The configuration of the head-up display device 100 in the above embodiment can appropriately be changed. For example, the reflective mirror member 20 may not be provided, and the mirror unit 30 may directly be irradiated with the display light L from the display unit 10.

The positions of the first to third positioning recessed sections 36a to 36c in the concave mirror holder 35 may appropriately be switched. Furthermore, the number of the positioning recessed sections 36a to 36c and the positioning projected sections 32a to 32c may be increased or reduced.

In the above embodiment, the concave mirror holder 35 is formed with the first to third positioning recessed sections 36a to 36c, and the concave mirror 31 is formed with the first to third positioning projected sections 32a to 32c. However, in an opposing fashion, the concave mirror holder 35 may be formed with the first to third positioning projected sections 32a to 32c, and the concave mirror 31 may be formed with the first to third positioning recessed sections 36a to 36c.

The shapes of the first to third positioning recessed sections 36a to 36c in the concave mirror holder 35 may appropriately be changed. For example, all of the positioning recessed sections may have the same shape as the first positioning recessed section 36a.

The first positioning recessed section 36a is formed in the conical shape but may be formed in a columnar shape. In addition, the second positioning recessed section 36b may be formed in a U-shape or an angled U-shape, for example, instead of the V-shape.

In the above embodiment, each of the first to third positioning projected sections 32a to 32c is formed in the columnar shape having the spherical tip. However, each of the first to third positioning projected sections 32a to 32c is not limited thereto and may be formed to have the tip in the columnar shape or a semispherical shape, for example.

In the above embodiment, the concave mirror holder 35 is provided with the adhesive surface sections 37a to 37e. However, the number and the arrangement aspect of the adhesive surface sections are not limited thereto and can appropriately be changed. In addition, any of the adhesive surface sections 37a to 37e may not be provided.

In the above embodiment, for example, the solid adhesive containing the heat-reversible resin component is adopted as the adhesive 46. However, a two-sided adhesive tape may be adopted as the adhesive.

In the above embodiment, the head-up display device 100 is mounted on the vehicle 200 but may be mounted on a vehicle other than the vehicle 200 such as an aircraft or a watercraft. In addition, the projection member is not limited to the front glass but may be a dedicated combiner.

In the above embodiment, the displacement occurrence region 35a is the rectangle that is long in the X-direction and provided in the upper left portion of the front surface 35f of the concave mirror holder 35. However, the shape of the displacement occurrence region 35a can appropriately be changed. For example, as indicated by one-dot chain lines in FIG. 7, a displacement occurrence region 35A may have a triangular shape. In detail, the displacement occurrence region 35A has a right triangular shape in which the X-direction corresponds to a height direction, a base thereof is located on the left side, and a vertex is located on the right side. A first side that defines a right angle of the displacement occurrence region 35A is set along the upper edge of the main body 34, and a second side is set in a direction along a left edge of the main body 34. In this case, the adhesive surface section may be provided at the position on the outside of the displacement occurrence region 35A and within the displacement occurrence region 35a.

In the above embodiment, as an example, the technical idea described in Supplementary Note 1 below. Note that Supplementary Note 1 does not limit interpretation of the present invention in any way.

### (Supplementary Note 1)

A mirror unit that reflects display light from a display unit onto a projection member, the mirror unit comprising a concave mirror including a mirror surface that reflects the display light, a concave mirror holder including a main body that holds the concave mirror, a pair of rotational shafts that extends along a rotational axis from both sides of the main body, and a held section that extends from the main body in a direction crossing the rotational axis, a mirror drive unit that includes a holding concave section sandwiching the held section from a direction orthogonal to the rotation axis and causes the concave mirror holder to rotate with the concave mirror about the rotation axis by moving the holding concave section along the direction orthogonal to the rotation axis, a torsion spring including a coil that is inserted through any one of the pair of rotational shafts and a biasing part that extends from the coil and biases the concave mirror holder so as to bring the held section into contact with the holding concave section, and a contact section that contacts the concave mirror provided in the concave mirror holder, wherein the contact section is provided in a region of the concave mirror holder excluding a displacement occurrence region where displacement possibly occurs when the biasing part biases the concave mirror holder.

### DESCRIPTION OF REFERENCE NUMERALS

1 Viewer
10 Display unit
20 Reflective mirror member
30 Mirror unit
31 Concave mirror
31a Mirror surface
31b Back surface
32a First positioning projected section
32b Second positioning projected section
32c Third positioning projected section
33 Biased section
33a Locking hole
34 Main body
34a to 34i Rib
35 Concave mirror holder
35a Displacement occurrence region
35f Front surface
36a First positioning recessed section
36b Second positioning recessed section
36c Third positioning recessed section
36c1 Bottom surface
36c2 Side surface
37a to 37h Adhesive surface section
37j Concave-convex groove
37a to 37e First to fifth adhesive surface section
38 Held section
38a, 38b Shaft holder
39a, 39b Rotational shaft
40 Mirror drive unit
41 Motor
42 Conversion mechanism
42a Screw shaft
42b Movable section
42c Holding concave section
42c1 Contact surface
45 Torsion spring
45a Coil
45b Biasing part
45c Locking section
60 Casing
70 Control unit
100 Head-up display device
200 Vehicle
201 Front glass

1. A head-up display device comprising: a display unit that emits display light; and a mirror unit that reflects the display light from the display unit onto a projection member, wherein
the mirror unit includes:
a concave mirror including a mirror surface that reflects the display light;
a concave mirror holder including a main body that holds the concave mirror, a pair of rotational shafts that extends along a rotational axis from both sides of the main body, and a held section that extends from the main body in a direction crossing the rotational axis;
a mirror drive unit that includes a holding concave section sandwiching the held section from a direction orthogonal to the rotation axis and causes the concave mirror holder to rotate with the concave mirror about the rotation axis by moving the holding concave section along the direction orthogonal to the rotation axis;
a torsion spring including a coil that is inserted through any one of the pair of rotational shafts and a biasing part that extends from the coil and biases the concave mirror holder so as to bring the held section into contact with the holding concave section; and
a contact section that contacts the concave mirror provided in the concave mirror holder, and
the contact section is provided in a region of the concave mirror holder excluding a displacement occurrence region where displacement possibly occurs when the biasing part biases the concave mirror holder.

2. The head-up display device according to claim 1, wherein
the biasing part is locked to a side surface of the concave mirror holder, and
the displacement occurrence region is formed in a region of a front surface of the concave mirror holder and the region being farther from the rotational shaft than a position at which the biasing part is locked.

3. The head-up display device according to claim 1, wherein
the main body includes an inclined surface that is formed at an end of the displacement occurrence region far from the position at which the biasing part is locked and that is inclined in a manner to be separated from a back surface of the concave mirror as being separated from the rotational shaft.

4. The head-up display device according to claim 1, wherein
the contact section includes:
an adhesive surface section that adheres to the concave mirror; and
a holder positioning section that contacts a concave mirror positioning section formed in the concave mirror so as to determine a position of the concave mirror with respect to the concave mirror holder.

5. The head-up display device according to claim 4, wherein
the main body has a rectangular plate shape that is long along the rotation axis, and
the three holder positioning sections each are arranged to be positioned at three vertices of a triangle that has a short side extending in a direction orthogonal to the rotational axis of the main body as a base and a long side thereof extending along the rotation axis as a height.

6. The head-up display device according to claim 5, wherein
of the three holder positioning sections, a first holder positioning section has a conical hole to which the concave mirror positioning section in a convex shape is fitted,
of the three holder positioning sections, a second holder positioning section has a V-shaped hole to which the concave mirror positioning section in the convex shape is fitted and which extends along an imaginary connection line connecting the first holder positioning section and the second holder positioning section; and
of the three holder positioning sections, a third holder positioning section has a plane that the concave mirror positioning section in the convex shape abuts.

7. The head-up display device according to claim 2, wherein
the main body includes an inclined surface that is formed at an end of the displacement occurrence region far from the position at which the biasing part is locked and that is inclined in a manner to be separated from a back surface of the concave mirror as being separated from the rotational shaft.
